(19) United States
(12) Patent Application Publication
(10) Pub. No.: US 2020/0113663 A1
(43) Pub. Date: Apr. 16, 2020

(54) OCCLUSION TRANSFER DEVICE AND FACEBOW-FREE TRANSFER METHOD

(71) Applicant: NATIONAL CHENG KUNG UNIVERSITY, Tainan City (TW)

(72) Inventors: Jing-Jing FANG, Tainan City (TW); Tung-Yiu WONG, Tainan City (TW); Te-Yu LIN, Kaohsiung City (TW)

(21) Appl. No.: 16/215,016

(22) Filed: Dec. 10, 2018

(30) Foreign Application Priority Data
Oct. 11, 2018 (TW) 107135772

(51) Int. Cl. A61C 19/045; A61C 7/00; A61C 19/05

(52) U.S. Cl. CPC A61C 19/045; A61C 11/005; A61C 19/05; A61C 7/002

(57) ABSTRACT

A facebow-free transfer method includes: registering virtual upper and lower casts respectively to an upper teeth part of a virtual maxilla model and a lower teeth part of a virtual mandible model so as to form a virtual teeth and jaw model; mounting the virtual teeth and jaw model on a virtual articulator; generating a virtual occlusion transfer module that is mounted on the virtual articulator and that has a part extending to and fitting in an in-between space of virtual upper and lower casts of the virtual teeth and jaw model; and creating an actual occlusion transfer device that is to be mounted on an articulator based on the virtual occlusion transfer module.

### CROSS-REFERENCE TO RELATED APPLICATION

This application claims priority of Taiwanese Invention Patent Application No. 107135772, filed on Oct. 11, 2018.

### FIELD

The disclosure relates to an occlusion transfer device and a facebow-free transfer method, and more particularly to an occlusion transfer device and a facebow-free transfer method adapted to transfer an occlusal relationship between a maxilla and a mandible of a subject to an articulator that associated dental casts uniquely of the subject are mounted on.

### BACKGROUND

For orthognathic surgery, a conventional approach to build a model for surgical planning is implemented to utilize a facebow to transfer an occlusal relationship of a patient via a dental plaster cast to an articulator so as to enable a medical professional to plan orthognathic surgery using the articulator.

However, transfer of the occlusal relationship by the facebow requires the patient to show up in person at a hospital, and requires a well-trained medical professional to manually operate the facebow, which has proven to be quite inconvenient in practice. Moreover, to transfer the occlusal relationship of the patient to the articulator, mechanisms of the facebow should be properly fixed when the facebow has been set up on the face of the patient. Once parts of the mechanisms of the facebow are loosened, the occlusal relationship of the patient recorded by the facebow cannot be reproduced, resulting in troublesome of use. Furthermore, for cases of severe deformation of the jaw or face, facebow available on the market may not completely record the occlusal relationship, causing a restriction on use of the facebow. However, aside from a conventional facebow, there is no other way to transfer the occlusal relationship of the patient to the articulator.

### SUMMARY

Therefore, an object of the disclosure is to provide an occlusion transfer device and a facebow-free transfer method that can overcome at least one of the drawbacks of the prior art.

According to one aspect of the disclosure, the facebow-free transfer method is adapted to transfer an occlusal relationship between a maxilla and a mandible of a subject to an articulator that an associated dental cast uniquely of the subject is mounted on. The facebow-free transfer method includes steps of:

(A) by an image processor based on image registration, registering a virtual upper cast that corresponds to an upper cast of the associated dental cast to an upper teeth part of a virtual maxilla model established based on the maxilla of the subject, and registering a virtual lower cast that corresponds to a lower cast of the associated dental cast to a lower teeth part of a virtual mandible model established based on the mandible of the subject, the virtual upper cast, the virtual lower cast, the virtual maxilla model and the virtual mandible model cooperatively forming a virtual teeth and jaw model;

(B) by the image processor, mounting the virtual teeth and jaw model on a virtual articulator that corresponds to the articulator;

(C) by the image processor, generating a virtual occlusion transfer module that is mounted on the virtual articulator and that has a part extending to and fitting in an in-between space of the virtual upper cast and the virtual lower cast of the virtual teeth and jaw model; and

(D) by an output device, creating, based on the virtual occlusion transfer module, an actual occlusion transfer device that is to be mounted on the articulator.

According to another aspect of the disclosure, the facebow-free transfer method is adapted to transfer an occlusal relationship between a maxilla and a mandible of a subject to an articulator that an associated dental cast uniquely of the subject is mounted on. The facebow-free transfer method includes steps of:

(a) by an image processor based on image registration, registering a virtual upper cast that corresponds to an upper cast of the associated dental cast to an upper teeth part of a virtual maxilla model established based on the maxilla of the subject, and registering a virtual lower cast that corresponds to a lower cast of the associated dental cast to a lower teeth part of a virtual mandible model established based on the actual mandible of the subject, the virtual upper cast, the virtual lower cast, the virtual maxilla model and the virtual mandible model cooperatively forming as a virtual teeth and jaw model;

(b) by the image processor, mounting the virtual teeth and jaw model on a virtual articulator that corresponds to the articulator;

(c) by the image processor, generating a virtual bite piece that extends to and fits in an in-between space of the virtual upper cast and the virtual lower cast of the virtual teeth and jaw model and that has a virtual attachment portion;

(d) by the image processor, determining relative positioning coordinates of the virtual attachment portion of the virtual bite piece with respect to reference coordinates associated with the virtual articulator;

(e) by an output device, creating, based on the virtual bite piece, an actual bite piece that has an actual attachment portion corresponding to the virtual attachment portion and to be attached to a movement device; and

(f) driving the movement device that is set to a default position, which corresponds to the reference coordinates, with respect to the articulator and that is attached with the actual attachment portion to bring the actual bite piece to move with respect to the default position based on the relative positioning coordinates.

### BRIEF DESCRIPTION OF THE DRAWINGS

Other features and advantages of the disclosure will become apparent in the following detailed description of the embodiments with reference to the accompanying drawings, of which:

FIG. 1 is a flow chart illustrating a first embodiment of a facebow-free transfer method according to the disclosure;

FIG. 2 includes parts (A) and (B) which are schematic diagrams illustrating an embodiment of registering a virtual upper cast to an upper teeth part of a virtual maxilla model, and registering a virtual lower cast to a lower teeth part of a virtual mandible model;

FIG. 3 includes parts (A) to (C) which are schematic diagrams illustrating an embodiment of forming a virtual teeth and jaw model by first registering a combination of the virtual upper cast and the virtual lower cast to the virtual maxilla model, and then registering the virtual mandible model to the virtual lower cast;

FIG. 4 is a perspective schematic view illustrating an embodiment of an articulator and an actual positioning component;

FIG. 5 is a schematic diagram illustrating an embodiment where the virtual teeth and jaw model is mounted on a virtual articulator and a virtual occlusion transfer module is generated with reference to the virtual teeth and jaw model;

FIG. 6 is a schematic diagram illustrating an embodiment where an occlusion transfer device and an associated dental cast are mounted on the articulator;

FIG. 7 is a flow chart illustrating a second embodiment of the facebow-free transfer method according to the disclosure;

FIG. 8 is a schematic diagram illustrating an embodiment where the virtual teeth and jaw model is mounted on the virtual articulator and a virtual bite piece is generated with reference to the virtual teeth and jaw model;

FIG. 9 is a front schematic diagram illustrating an embodiment where a movement device is attached to an actual registering component;

FIG. 10 is a front schematic diagram illustrating an embodiment where the movement device arranges the actual bite piece with respect to the articulator; and

FIG. 11 is a top schematic diagram illustrating an embodiment where the movement device arranges the actual bite piece with respect to the articulator.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

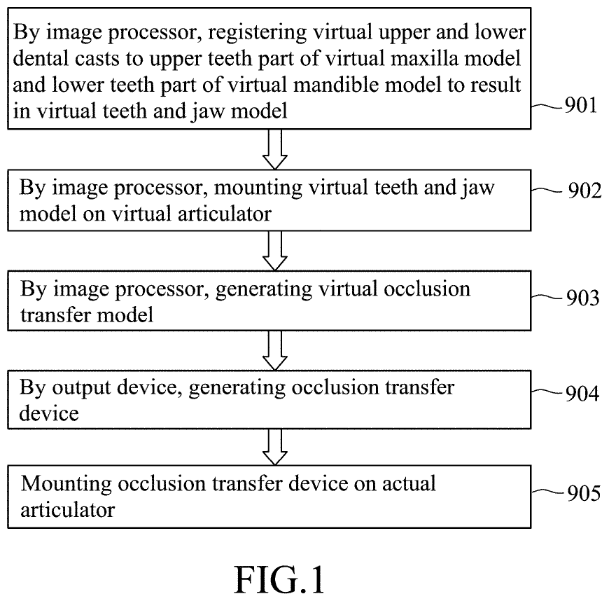

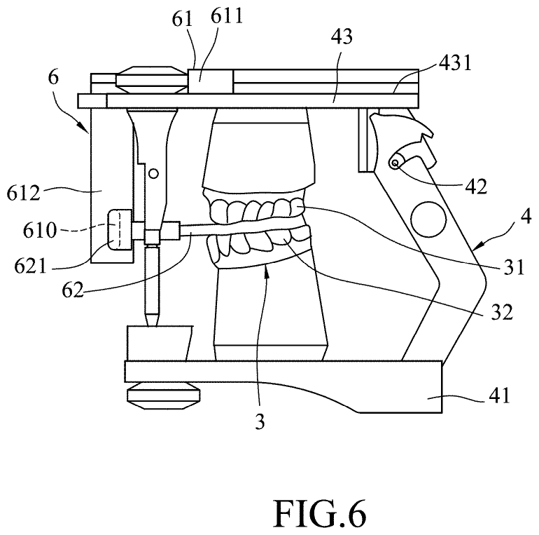

Referring to FIGS. 1, 4 and 6, a first embodiment of a facebow-free transfer method according to the disclosure is illustrated. The facebow-free transfer method is adapted to transfer an occlusal relationship between a maxilla and a mandible of a subject to an articulator 4 (physically present in the real world, as opposed to virtual) that an associated dental cast 3 uniquely of the subject is mounted on without using any facebow, so as to allow the associated dental cast 3 mounted on the articulator 4 to accurately reproduce the occlusal relationship between the maxilla and the mandible of the subject. In this embodiment, the dental cast 3 is obtained by making a dental impression of the subject using conventional technique, and then molding the dental cast 3 from the dental impression thus made, so the dental cast 3 is uniquely representative of the subject's dental/oral structure. In this embodiment, the subject is a patient to be treated by orthognathic surgery, but is not limited thereto.

The associated dental cast 3 includes an upper cast 31 and a lower cast 32. In this embodiment, the associated dental cast 3 is made of plaster, but the material of the associated dental cast 3 is not limited to the disclosure herein and may vary in other embodiments.

The articulator 4 includes a base 41, and an upper arm 43 that is pivotally connected via a transversal shaft 42 to the base 41. The upper arm 43 defines a plane 431. The base 41 and the upper arm 43 are configured for mounting of the lower cast 32 and the upper cast 31 of the associated dental cast 3, respectively. Since methods of mounting the lower cast 32 and the upper cast 31 of the associated dental cast 3 respectively on the base 41 and the upper arm 43 of the articulator 4 have been well known to one skilled in the relevant art, detailed explanation of the same is omitted herein for the sake of brevity.

As shown in FIG. 1, the facebow-free transfer method includes steps 901 to 905 described as follows.

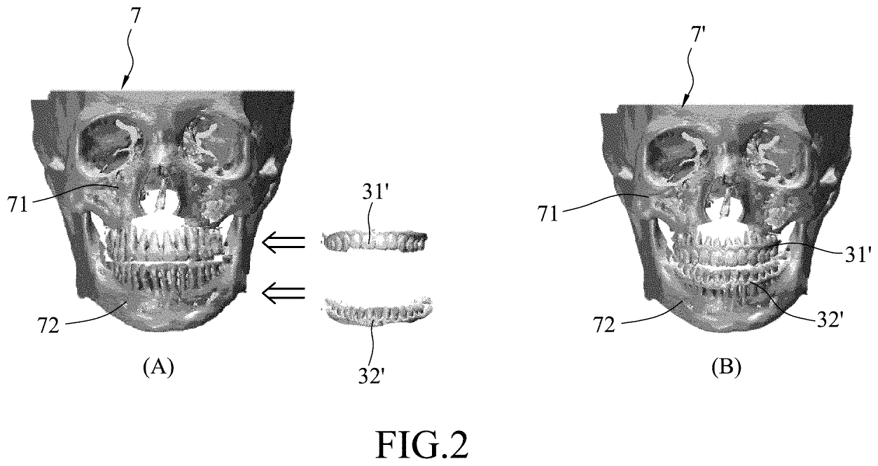

Reference is made further to FIG. 2. In step 901, according to a user operation, an image processor (not shown) loads a virtual upper cast 31′ that corresponds to the upper cast 31 of the associated dental cast 3 (the virtual upper cast 31′ being a duplication of the upper cast 31 in the virtual world), a virtual lower cast 32′ that corresponds to the lower cast 32 of the associated dental cast 3 (the virtual lower cast 32′ being a duplication of the lower cast 32 in the virtual world), and a three-dimensional (3D) virtual jaw model 7 that corresponds uniquely to the subject and that is established based on computed tomography (CT) scan. In this embodiment, the image processor is implemented to be a processor of a personal computer or a server computer, or any circuitry configurable/programmable to carry out the operations described herein, but implementation of the image processor is not limited to the disclosure herein and may vary in other embodiments.

As shown in FIG. 2, the 3D virtual jaw model 7 includes a virtual maxilla model 71 established based on the maxilla of the subject (so the virtual maxilla model 71 is uniquely associated with the subject), and a virtual mandible model 72 established based on the mandible of the subject (so the virtual mandible model 72 is uniquely associated with the subject). Through image registration, the image processor registers the virtual upper cast 31′ to an upper teeth part of the virtual maxilla model 71 so the virtual upper cast 31′ substitutes for the upper teeth part, and registers the virtual lower cast 32′ to a lower teeth part of the virtual mandible model 72 so the virtual lower cast 32′ substitutes for the lower teeth part (see part (A) of FIG. 2). In this way, the virtual upper cast 31′, the virtual lower cast 32′, the virtual maxilla model 71 and the virtual mandible model 72 cooperatively forms a virtual teeth and jaw model 7′ (see part (B) of FIG. 2). In this embodiment, the process of image registration includes a stage of pre-registration and a stage of fine registration. In the following paragraphs, registering the virtual upper cast 31′ to the upper teeth part of the virtual maxilla model 71 is taken as an example for explanation.

In the stage of pre-registration, a user utilizes the image processor to mark a set of tag points on the upper teeth part of the virtual maxilla model 71 and to mark another set of tag points on the virtual upper cast 31′ for coarsely registering the virtual upper cast 31′ to the upper teeth part of the virtual maxilla model 71 by performing coordinate transformation between the two sets of tag points.

In the stage of fine registration, the user utilizes the image processor to select respective areas of the virtual upper cast 31′ and the upper teeth part of the virtual maxilla model 71 that are similar in geometric shape to perform the Iterative Closest Point (ICP) algorithm so as to progressively register the virtual upper cast 31′ to the upper teeth part of the virtual maxilla model 71 at a local scale.

It should be noted that since image registration techniques have been well known, detailed explanation of the same is omitted herein for the sake of brevity. In addition, the process of image registration is not limited to the disclosure herein and may vary in other embodiments. For example, for two kinds of orthognathic surgery such as surgery-first orthognathic approach (SFOA) and conventional correction-first orthognathic approach, different image registration processes are respectively utilized as will be described in the following paragraphs.

Referring to FIG. 2, for SFOA, the virtual maxilla model 71 and the virtual mandible model 72 as shown in part (A) of FIG. 2 are established by CT scan when the maxilla and the mandible of the subject are arranged in centric relation (CR). The virtual upper cast 31′ and the virtual lower cast 32′ are registered respectively to the upper teeth part of the virtual maxilla model 71 and the lower teeth part of the virtual mandible model 72 under a condition that the occlusal relationship between the virtual maxilla model 71 and the virtual mandible model 72 is maintained (to correspond to the occlusal relationship between the maxilla and the mandible of the subject). Consequently, arrangement of the virtual upper cast 31′ and the virtual lower cast 32′ in the virtual teeth and jaw model 7′ are maintained in CR after registration as shown in part (B) of FIG. 2.

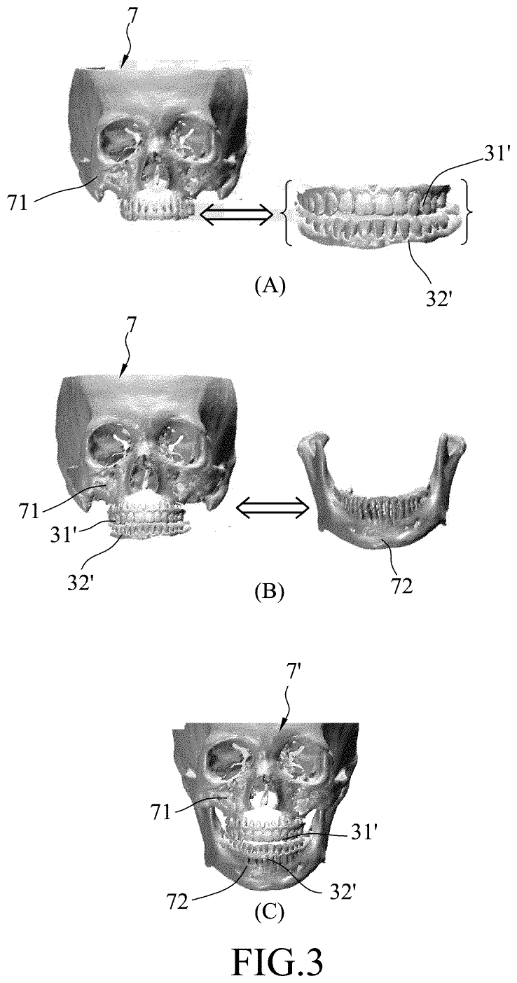

Referring to FIG. 3, for conventional correction-first orthognathic approach where arrangement of the virtual upper cast 31′ and the virtual lower cast 32′ has been made in CR in advance, the virtual upper cast 31′ and the virtual lower cast 32′ are registered respectively to the upper teeth part of the virtual maxilla model 71 and the lower teeth part of the virtual mandible model 72 that are established by CT scan when the maxilla and the mandible of the subject are arranged in centric occlusion (CO). Specifically speaking, the virtual maxilla model 71 and the virtual mandible model 72 are separated at the beginning. Under a condition that an occlusal relationship between the virtual upper cast 31′ and the virtual lower cast 32′ is maintained (to correspond of the occlusal relationship between the maxilla and the mandible of the subject), the image processor is controlled to first move together the virtual upper cast 31′ together with the virtual lower cast 32′, with the arrangement of the two being maintained in CR, so as to register the virtual upper cast 31′ to the upper teeth part of the virtual maxilla model 71 as shown in part (A) of FIG. 3, and then, to move the lower teeth part of the virtual mandible model 72 to be registered to the virtual lower cast 32′ as shown in part (B) of FIG. 3, so as to result in the virtual teeth and jaw model 7′ as shown in part (C) of FIG. 3. In this way, arrangement of the upper teeth part of the virtual maxilla model 71 and the lower teeth part of the virtual mandible model 72 is converted from CO to CR according to the arrangement of the virtual upper cast 31′ and the virtual lower cast 32′.

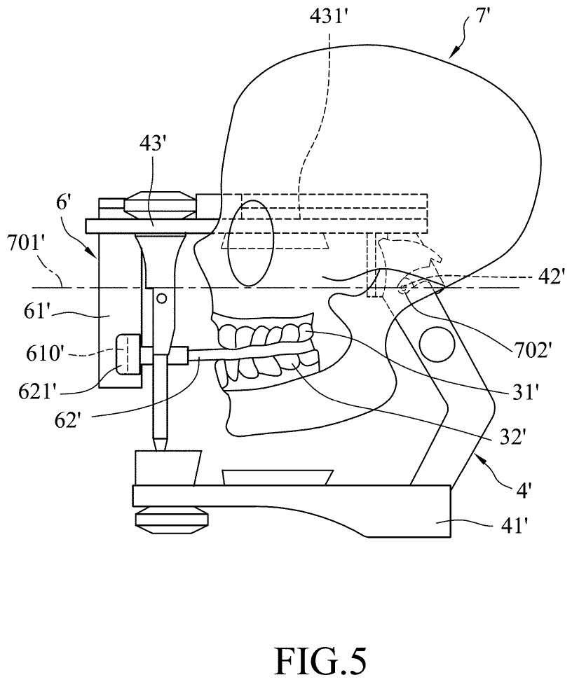

Referring to FIGS. 1 and 5, in step 902, the image processor mounts the virtual teeth and jaw model 7′ on a virtual articulator 4′ that corresponds to the articulator 4 (the virtual articulator 4′ is a representation of the articulator 4 in the virtual world) for mounting the associated dental cast 3. The virtual articulator 4′ is established by means of performing 3D scanning on the articulator 4. The virtual articulator 4′ includes a virtual base 41′, and a virtual upper arm 43′ that is pivotally connected via a virtual transversal shaft 42′ to the virtual base 41′.

The image processor displays the virtual teeth and jaw model 7′ for the user to mark feature points thereon. In this embodiment, the feature points are implemented as two points on the virtual teeth and jaw model 7′ which correspond respectively to mandibular condyles of the mandible of the subject, another two points on the virtual teeth and jaw model 7′ which correspond respectively to two lowest points of respective frames on orbital bones respectively at left and right sides of the subject, and still another two points on the virtual teeth and jaw model 7′ which correspond respectively to two upmost points of respective ear canals respectively at left and right sides of the subject. By analyzing coordinates of the aforementioned feature points, the image processor takes the feature points which correspond to the superior edge points of ear canals, and a midpoint of the feature points which correspond to the lowest points of respective frames on orbital bones to define a Frankfurt horizontal (FH) plane 701′ of the virtual teeth and jaw model 7′. In addition, the image processor further takes the two feature points which correspond respectively to the mandibular condyles of the mandible of the subject to define an imaginary line 702′ which passes through these two feature points.

Then, the image processor registers the imaginary line 702′ to the virtual transversal shaft 42′, and brings the FH plane 701′ of the virtual teeth and jaw model 7′ into being parallel with a virtual plane 431′ where the virtual arm 43′ is disposed, so as to mount the virtual teeth and jaw model 7′ on the virtual articulator 4′.

In step 903, the image processor generates a virtual occlusion transfer module 6′ that is mounted on the virtual articulator 4′ and that has a part extending to and fitting in an in-between space of the virtual upper cast 31′ and the virtual lower cast 32′ of the virtual teeth and jaw model 7′. Specifically speaking, the image processor generates a virtual positioning component 61′ mounted on the virtual articulator 4′, and a virtual bite piece 62′ to serve as the part of the virtual occlusion transfer module 6′ that is between the virtual upper cast 31′ and the virtual lower cast 32′ of the virtual teeth and jaw model 7′. In this embodiment, the virtual bite piece 62′ generated by the image processor extends to and fits in the in-between space of the virtual upper cast 31′ and the virtual lower cast 32′ of the virtual teeth and jaw model 7′, and has a virtual attachment portion 621′ that is capable of being separated from and engaged to a receiving hole 610′ formed in the virtual positioning component 61′. The virtual positioning component 61′ and the virtual bite piece 62′ are connected together to cooperatively form the virtual occlusion transfer module 6′.

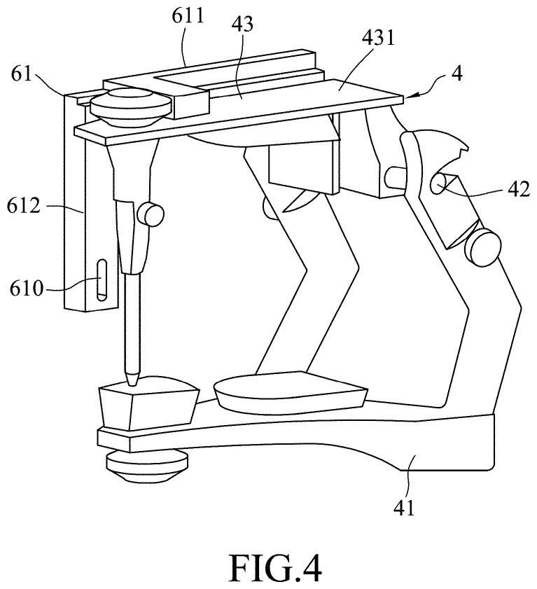

Referring back to FIG. 4, in this embodiment, the virtual positioning component 61′ (see FIG. 5) is established by means of performing 3D scanning on an actual positioning component 61. The actual positioning component 61 has a fastening segment 611 that is configured to be fastened to the upper arm 43 of the articulator 4, and a connecting segment 612 that extends downward from a front end of the fastening segment 611 and that has a receiving hole 610. It should be noted that in practice, a structure of the actual positioning component 61 may vary according to different designs of the articulator 4 so as to enable the actual positioning component 61 to be fastened to the articulator 4. Therefore, the structure of the actual positioning component 61 is not limited to the disclosure herein and may vary in other embodiments.

Referring to FIGS. 1, 5 and 6, in step 904, an output device (not shown), by using 3D printing technology, creates an actual occlusion transfer device 6 that is to be mounted on the articulator 4 based on the virtual occlusion transfer module 6′. In this embodiment, the output device is implemented to be a 3D printer and the 3D printing technology is implemented to be stereolithography, but implementations of the output device and the 3D printing technology are not limited to the disclosure herein and may vary in other embodiments.

Specifically speaking, in one embodiment, the output device, by using 3D printing technology, creates a duplicate of the actual positioning component 61 based on the virtual positioning component 61′ and an actual bite piece 62 based on the virtual bite piece 62′. The 3D-printed actual bite piece 62 is configured to be connected to the 3D-printed actual positioning component 61, and to be bitten between the upper cast 31 and the lower cast 32 of the associated dental cast 3 for fitting of the associated dental cast 3 to the occlusion transfer device 6. Once connected together, the 3D-printed actual positioning component 61 and the 3D-printed actual bite piece 62 cooperatively form the actual occlusion transfer device 6.

In one embodiment, the output device creates, by using 3D printing technology based on the virtual bite piece 62′, the actual bite piece 62 that is to be combined with the actual positioning component 61 based on which the virtual positioning component 61′ is established, to form the actual occlusion transfer device 6.

In one embodiment, the output device by using 3D printing technology, directly creates the actual occlusion transfer device 6 as one piece based on a combination of the virtual positioning component 61′ and the virtual bite piece 62′ which have been connected together to form the virtual occlusion transfer module 6′. In this case, the actual positioning component 61 that has previously undergone 3D scanning to obtain the virtual positioning component 61′ is not to be used as part of the actual occlusion transfer device 6.

In step 905, the actual occlusion transfer device 6 is mounted on the articulator 4. Since the actual occlusion transfer device 6 is created based on a combination of the virtual teeth and jaw model 7′ and the virtual articulator 4′, when the actual occlusion transfer device 6 is mounted on the articulator 4, a position where the actual bite piece 62 is arranged with respect to the articulator 4 will be related to the occlusal relationship between the maxilla and the mandible of the subject that are arranged in CR. Therefore, when the associated dental cast 3 is arranged to bite the actual bite piece 62 to have a profile matching relationship with the actual bite piece 62 and is mounted to the articulator 4, without using the facebow, the occlusal relationship between the maxilla and the mandible of the subject can be accurately transferred to the articulator 4, and the upper cast 31 and the lower cast 32 of the associated dental cast 3 mounted on the articulator 4 can be arranged in CR.

It should be noted that the order of performing the generation of the virtual bite piece 62′ is not limited to the disclosure herein. In one embodiment, succeeding to step 901, the image processor generates the virtual bite piece 62′ between the virtual upper cast 31′ and the virtual lower cast 32′ of the virtual teeth and jaw model 7′, and then mounts the virtual teeth and jaw model 7′ together with the virtual bite piece 62′ on the virtual articulator 4′ in step 902. Subsequently, the image processor generates the virtual positioning component 61′ mounted on the virtual articulator 4′ and connects the virtual positioning component 61′ and the virtual bite piece 62′ in step 903. Thereafter, the output device is able to create the actual positioning component 61 and/or the actual bite piece 62.

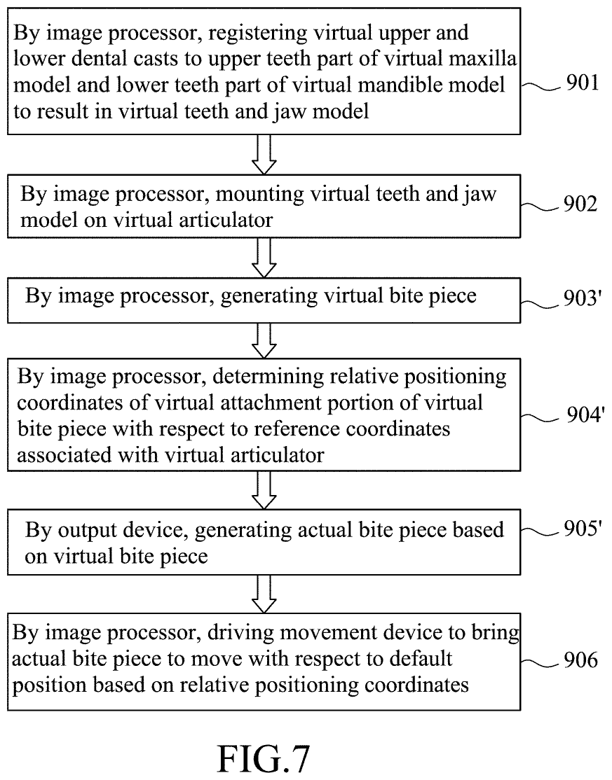

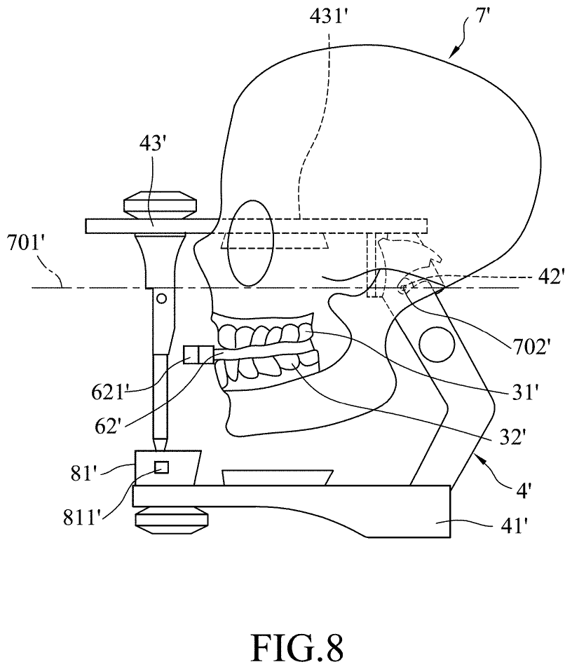

Referring to FIGS. 7 and 8, a second embodiment of the facebow-free transfer method according to the disclosure is illustrated. For the sake of brevity and clarity, similar parts between the second embodiment and the first embodiment are omitted, and only different parts thereof are described as follows.

In step 903′, the image processor generates the virtual bite piece 62′ that extends to and fits in the in-between space of the virtual upper cast 31′ and the virtual lower cast 32′ of the virtual teeth and jaw model 7′ and that has a virtual attachment portion 621′.

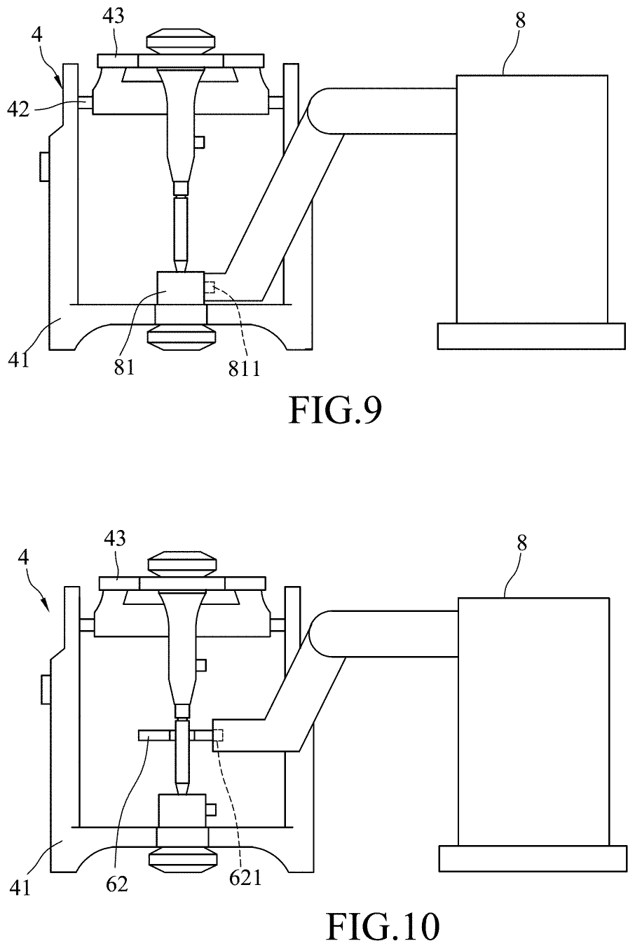

Referring further to FIG. 9, in step 904′, the image processor determines relative positioning coordinates of the virtual attachment portion 621′ of the virtual bite piece 62′ with respect to a reference coordinates associated with the virtual articulator 4′.

In this embodiment, a virtual registering component 81′ is established by means of performing 3D scanning on an actual registering component 81. In other words, the virtual registering component 81′ is a representation of the actual registering component 81 in the virtual world. The actual registering component 81 is formed with a hold portion 811 that is identical in shape with an attachment portion 621 (see FIG. 10), which corresponds to the virtual attachment portion 621′, of the actual bite piece 62 (see FIG. 10) and that is to be attached to a movement device 9, which exists in the physical world, as depicted in FIG. 9. In step 904′, the virtual registering component 81′ is positioned at a specific location on the virtual articulator 4′. For example, the virtual registering component 81′ is positioned on the virtual base 41′ of the virtual articulator 4′. Moreover, coordinates of the position of a virtual hold portion 811′, which corresponds to the hold portion 811 of the actual registering component 81, of the virtual registering component 81′ are chosen to serve as the reference coordinates associated with the virtual articulator 4′, and the relative positioning coordinates of the virtual attachment portion 621′ of the virtual bite piece 62′ with respect to the reference coordinates can be determined.

In this embodiment, the movement device 9 is implemented to be a robotic arm, a Steward platform, or any device that is capable of multiaxis movement, grasping, or being connected to the hold portion 811 of the actual registering component 81. Implementation of the movement device 9 is not limited to the disclosure herein and may vary in other embodiments.

It should be noted that there are a lot of ways to determine the relative positioning coordinates of the virtual attachment portion 621′ of the virtual bite piece 62′ with respect to the reference coordinates, and the way to determine the relative positioning coordinates is not limited to the disclosure herein and may vary in other embodiments.

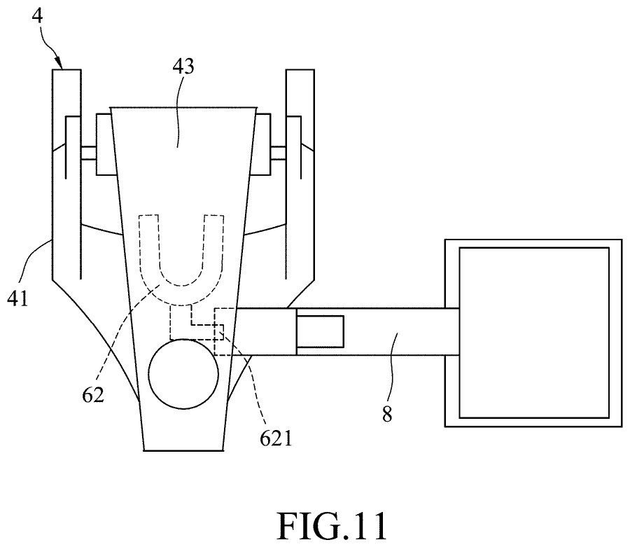

Referring further to FIG. 11, in step 905′, based on the virtual bite piece 62′, the output device creates the actual bite piece 62 that has the actual attachment portion 621 corresponding to the virtual attachment portion 621′ and to be attached to the movement device 8. In this embodiment, the output device creates the actual bite piece 62 by using 3D printing technology, but implementation of creating the actual bite piece 62 is not limited to the disclosure herein and may vary in other embodiments.

Referring to FIGS. 7 to 9, in step 906, the actual registering component 81 is disposed on the base 41 of the articulator 4 at a position corresponding to the specific location where the virtual registering component 81′ is positioned on the virtual articulator 4′. The movement device 9, which is located adjacent to the articulator 4, is controlled to be attached to the actual registering component 81 by grasping the hold portion 811 of the actual registering component 81. In this way, the movement device 9 is set to a default position, which corresponds to the reference coordinates, with respect to the articulator 4. In other words, the position of the hold portion 811 of the actual registering component 81 serves as the reference coordinates with respect to which the movement device 9 is going to move the actual bite piece 62 (see FIG. 10).

Referring to FIGS. 8, 10 and 11, the movement device 9 is driven to grasp the actual attachment portion 621 of the actual bite piece 62, and to bring the actual bite piece 62 to move with respect to the default position based on the relative positioning coordinates obtained in step 904′. In one embodiment, the movement device 9 may be driven by a processor in communication therewith, one example of which may be the image processor mentioned above. Consequently, the occlusal relationship between the maxilla and the mandible of the subject can be accurately transferred to the articulator 4. Then, a medical professional is able to mount the associated dental cast 3 on the articulator 4 in such a manner that the associated dental cast 3 bites the actual bite piece 62 to have a profile matching relationship therewith, so the upper cast 31 and the lower cast 32 of the associated dental cast 3 may be arranged to CR. In this way, the medical professional may plan orthognathic surgery with the aid of the associated dental cast 3.

In summary, the facebow-free transfer method according to the disclosure includes steps of registering the virtual upper cast 31′ and the lower virtual dental cast 32′ respectively to the upper teeth part of the virtual maxilla model and the lower teeth part of the virtual mandible model so as to form the virtual teeth and jaw model 7′, mounting the virtual teeth and jaw model 7′ on the virtual articulator 4′, generating the virtual occlusion transfer module 6′ or the virtual bite piece 62′, and then, physically creating (i.e., in the real world), the actual occlusion transfer device 6 based on the virtual occlusion transfer module 6′, or creating the actual bite piece 62 based on the virtual bite piece 62′. By mounting the actual occlusion transfer device 6 on the articulator 4, or by attaching the actual bite piece 62 to the movement device 9 which later brings the actual bite piece 62 to a desired position, transfer of the occlusal relationship to the articulator 4 may be realized to allow medical professionals to plan the orthognathic surgery, without involving a facebow in the entire process.

Since a facebow is not required in the transfer method according to the disclosure, the subject does not have to wear the facebow, and only has to get the CT scan of his/her skull and to undergo the process of establishment of the associated dental cast 3 uniquely associated with him/her. In addition, the actual occlusion transfer device 6 and the actual bite piece 62 are duplicable using 3D printing technology, and data related to occlusal relationship of the subject can be digitalized and shared via computers and/or networks by different medical professionals at different hospitals, facilitating orthognathic surgery planning. Moreover, the transfer method according to the disclosure can be applied to articulators of any brands, models or design, greatly enhancing flexibility.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A facebow-free transfer method adapted to transfer an occlusal relationship between a maxilla and a mandible of a subject to an articulator that an associated dental cast uniquely of the subject is mounted on, the facebow-free transfer method comprising:
(A) by an image processor based on image registration, registering a virtual upper cast that corresponds to an upper cast of the associated dental cast to an upper teeth part of a virtual maxilla model established based on the maxilla of the subject, and registering a virtual lower cast that corresponds to a lower cast of the associated dental cast to a lower teeth part of a virtual mandible model established based on the mandible of the subject, the virtual upper cast, the virtual lower cast, the virtual maxilla model and the virtual mandible model cooperatively forming a virtual teeth and jaw model;
(B) by the image processor, mounting the virtual teeth and jaw model on a virtual articulator that corresponds to the articulator;
(C) by the image processor, generating a virtual occlusion transfer module that is mounted on the virtual articulator and that has a part extending to and fitting in an in-between space of the virtual upper cast and the virtual lower cast of the virtual teeth and jaw model; and
(D) by an output device, creating, based on the virtual occlusion transfer module, an actual occlusion transfer device that is to be mounted on the articulator.

2. The method as claimed in claim 1, wherein step (A) includes registering the virtual upper cast and the virtual lower cast respectively to the upper teeth part of the virtual maxilla model and the lower teeth part of the virtual mandible model under a condition that an occlusal relationship between the virtual maxilla model and the virtual mandible model is maintained.

3. The method as claimed in claim 1, wherein step (A) includes registering the upper teeth part of the virtual maxilla model and the lower teeth part of the virtual mandible respectively to the virtual upper cast and the virtual lower cast under a condition that an occlusal relationship between the virtual upper cast and the virtual lower cast is maintained.

4. The method as claimed in claim 1, wherein step (D) includes by the output device, creating the actual occlusion transfer device by using three-dimensional (3D) printing technology.

5. The method as claimed in claim 1, wherein:
step (C) includes by the image processor, generating a virtual positioning component mounted on the virtual articulator, and an virtual bite piece to serve as the part of the virtual occlusion transfer module between the virtual upper cast and the virtual lower cast of the virtual teeth and jaw model, the virtual positioning component and the virtual bite piece being connected together to cooperatively form the virtual occlusion transfer module;
step (D) includes by the output device using 3D printing technology, creating an actual positioning component based on the virtual positioning component and an actual bite piece based on the virtual bite piece which are connected together to cooperatively form the actual occlusion transfer device.

6. The method as claimed in claim 1, wherein:
step (C) includes by the image processor, generating a virtual positioning component mounted on the virtual articulator, and an virtual bite piece to serve as the part of the virtual occlusion transfer module (6′) between the virtual upper cast and the virtual lower cast of the virtual teeth and jaw model, the virtual positioning component and the virtual bite piece being connected together to cooperatively form the virtual occlusion transfer module; and
step (D) includes, by the output device using 3D printing technology, creating, based on the virtual bite piece, an actual bite piece that is to be combined with an actual positioning component based on which the virtual positioning component is established to form the actual occlusion transfer device.

7. The method as claimed in claim 1, wherein:
the virtual articulator includes a virtual base, and a virtual upper arm that is pivotally connected via a virtual transversal shaft to the virtual base; and
step (B) includes by the image processor, registering an imaginary line, which passes through two points on the virtual teeth and jaw model corresponding respectively to mandibular condyles of the mandible of the subject, to the virtual transversal shaft, and bringing a Frankfurt horizontal (FH) plane of the virtual teeth and jaw model into being parallel with a virtual plane where the virtual arm is disposed, so as to mount the virtual teeth and jaw model on the virtual articulator.

8. A facebow-free transfer method adapted to transfer an occlusal relationship between a maxilla and a mandible of a subject to an articulator that an associated dental cast uniquely of the subject is mounted on, the facebow-free transfer method comprising:
(a) by an image processor based on image registration, registering a virtual upper cast that corresponds to an upper cast of the associated dental cast to an upper teeth part of a virtual maxilla model established based on the maxilla of the subject, and registering a virtual lower cast that corresponds to a lower cast of the associated dental cast to a lower teeth part of a virtual mandible model established based on the actual mandible of the subject, the virtual upper cast, the virtual lower cast, the virtual maxilla model and the virtual mandible model cooperatively forming a virtual teeth and jaw model;
(b) by the image processor, mounting the virtual teeth and jaw model on a virtual articulator that corresponds to the articulator;
(c) by the image processor, generating a virtual bite piece that extends to and fits in an in-between space of the virtual upper cast and the virtual lower cast of the virtual teeth and jaw model and that has a virtual attachment portion;
(d) by the image processor, determining relative positioning coordinates of the virtual attachment portion of the virtual bite piece with respect to a reference coordinates associated with the virtual articulator;
(e) by an output device, creating, based on the virtual bite piece, an actual bite piece that has an actual attachment portion corresponding to the virtual attachment portion and to be attached to a movement device; and
(f) driving the movement device that is set to a default position, which corresponds to the reference coordinates, with respect to the articulator, and that is attached with the actual attachment portion to bring the actual bite piece to move with respect to the default position based on the relative positioning coordinates.

9. The method as claimed in claim 8, wherein step (a) includes registering the virtual upper cast and the virtual lower cast respectively to the upper teeth part of the virtual maxilla model and the lower teeth part of the virtual mandible model under a condition that an occlusal relationship between the virtual maxilla model and the virtual mandible model is maintained.

10. The method as claimed in claim 8, wherein step (a) includes registering the upper teeth part of the virtual maxilla model and the lower teeth part of the virtual mandible model respectively to the virtual upper cast and the virtual lower cast under a condition that an occlusal relationship between the virtual upper cast and the virtual lower cast is maintained.

11. The method as claimed in claim 8, wherein step (e) includes by the output device, creating the actual occlusion transfer device by using three-dimensional (3D) printing technology.

12. The method as claimed in claim 8, wherein:
the virtual articulator includes a virtual base, and a virtual upper arm that is pivotally connected via a virtual transversal shaft to the virtual base; and
step (b) includes by the image processor, registering an imaginary line, which passes through two points on the virtual teeth and jaw model corresponding respectively to mandibular condyles of the mandible of the subject, to the virtual transversal shaft, and bringing a Frankfurt horizontal (FH) plane of the virtual teeth and jaw model into being parallel with a virtual plane where the virtual arm is disposed, so as to mount the virtual teeth and jaw model on the virtual articulator.

13. An actual occlusion transfer device, adapted to be mounted on an articulator for fitting of an associated dental cast, which is mounted on the articulator, to the actual occlusion transfer device, said actual occlusion transfer device being created by claim 4, said actual occlusion transfer device comprising:
an actual positioning component configured to be mounted on the articulator; and
an actual bite piece configured to be connected to said actual positioning component, and to be bitten between an upper cast and a lower cast of the associated dental cast to have a profile matching relationship therewith for fitting of the associated dental cast to the actual occlusion transfer device.

14. An actual occlusion configuring module, adapted to be mounted on an articulator for fitting of an associated dental cast, which is mounted on the articulator, to the actual occlusion transfer device, said actual occlusion transfer device comprising:
an actual positioning component configured to be mounted on the articulator; and
an actual bite piece created by claim 6, and configured to be connected to said actual positioning component, and to be bitten between an upper cast and a lower cast of the associated dental cast to have a profile matching relationship for fitting of the associated dental cast to the actual occlusion transfer device.
